(19) United States
(12) Patent Application Publication
(10) Pub. No.: US 2013/0092035 A1
(43) Pub. Date: Apr. 18, 2013

(54) Food bringing apparatus

(71) Applicant: Thomas G. Painter, JR., Center Valley, PA (US)

(72) Inventor: Thomas G. Painter, JR., Center Valley, PA (US)

(21) Appl. No.: 13/317,437

(22) Filed: Oct. 18, 2011

(51) Int. Cl. A23L 1/00

(52) U.S. Cl. 99/535

(57) ABSTRACT

A food brining apparatus is described that consists of a vessel for containing the brining solution and foodstuff, a series of paired inwardly extending tabs against which a foodstuff submergence retention means is vertically positioned to retain the foodstuff entirely submerged in the brining solution to counteract any foodstuff buoyancy, and a snap fit lid to maintain the interior environment of the brining solution separate from the external environment during the brining process. The foodstuff submergence retention means takes the form of a plate, a bar, a bar with perpendicularly extending arms, or a basket that are engaged with the paired inwardly extending tabs to maintain the foodstuffs submerged in the brining solution.

### BACKGROUND OF THE INVENTION

The present invention relates to a marinating or brining apparatus, and more particularly to a marinating device that is capable of retaining foodstuffs completely submerged within the brining solution within the food marinating container. There have been a number of marinating devices that create internal environments for the brining of foodstuffs within the container, but these fail to address the problem of maintaining the food stuff submerged in the brining solution to maximize the effect of the brine on the foodstuff.

During the process of preparing foodstuffs for cooking through the process of soaking foodstuffs, i.e., meats of various sources, there has existed a problem of maintaining the foodstuffs submerged completely within the brining solutions. Sometimes the foodstuffs tend to float upwards within the solutions, due to their buoyancy, partially emerging from the brining solution. This tendency to float in the brining solutions prohibits the full and complete moisture enhancement and acceptance of the food treatment, e.g., spice introduction, during the time required for the completion of the brining process.

Brining may be described as a foodstuffs cooking preparation including the soaking of the foodstuffs, for example meats, in a salt and spice solution for a predetermined period of time to enhance moisture retention and flavor of the foodstuffs. In order for the brining process to be fully effective, the foodstuffs must be completely submerged during the brining process. If the foodstuffs buoyancy lifts the food upwards and partially out of the solution, then the brining will not be entirely effective and could create problems when cooking the foodstuffs.

Brining is the application of two principles called diffusion and osmosis that tend to keep the moisture content of a foodstuff in equilibrium. The concentration of the brine solution (salt, spices and water) is in a much greater concentration outside of the foodstuff than that inside the foodstuff in the cells that make up the flesh of the subject foodstuff. The physical law of diffusion mandates that the greater concentration of the salt and spices in the brine solution will flow into the lesser concentration and be absorbed by the flesh of the foodstuff. Also, the greater concentration of the water in the brine solution will be absorbed into the flesh of the foodstuff by the process of osmosis.

Once the major components of the brine solution are absorbed into the flesh of the foodstuff they cause the proteins in the flesh to partially unravel, or denature. As the proteins unravel they become more likely to interact with one another forming a matrix that captures and retains the added moisture and, along with the moisture, the solids from the brine solution. This is accomplished in a reduced temperature environment ranging between 32° F. and 40° F., the common temperature range of a refrigerator. As the foodstuff is exposed to cooking heat, following the brining process, the protein cell matrix forms a barrier to retain the moisture and solid mixture within the foodstuff during the cooking process resulting in a moister and more fully seasoned foodstuff.

The best foodstuff candidates for brining are lean and often mildly flavored meats with a tendency to overcook such as chicken, turkey and pork. Some seafoods also take well to brining to prevent extreme moisture loss during cooking. Grilling a whole side of salmon following a period of brining allows the salmon to remain on the grill to absorb a smoky flavor without drying out. Shrimp is another acceptable choice for brining as it is extremely lean and often mushy in texture. The brining process actually firms the shrimp for cooking.

At a minimum, a brining solution will consist of water and salt. Other ingredients used to add flavor may include, sugar, brown sugar, candied ginger, honey, molasses, maple syrup, fruit juices, beer, liquor, bay leaves, rosemary, sage leaves, pickling spices, cloves, garlic, cinnamon, onion, chilies, citrus fruits, peppercorns, hot pepper flakes, thyme, mustard seed, coriander seed, and other herbs and spices. The solution is mixed together so that the principal ingredients of water and salt are entirely diffused and the additive “spices” are dispersed as equally as possible. The brining then takes place in the recommended temperature range between freezing and 40° F. for a period of time dependent upon the size of the container and the size and weight of the foodstuff being treated.

It is, therefore, one object of the present invention to provide a suitable container for fully submerging the foodstuff in the brining solution for the entirety of the brining process. It is also an object of the present invention to prevent the natural buoyancy of the foodstuff from partially uncovering the foodstuff and emerging from the brining solution during the process.

It is a further object of the present invention to provide a standard sized container for use with any size or weight of foodstuff that has an adjustment to accommodate larger or smaller foodstuffs without the need to change containers. It is a still further object to provide a container that is easily alterable to create a smaller or larger brining space within the container to accommodate foodstuffs of different sizes and weights.

Other objects will appear hereinafter.

### SUMMARY OF THE INVENTION

The brining apparatus of the present invention is designed for home or light commercial use. The brining apparatus is unique in that it attacks and solves the problem of buoyancy with certain meat types during the brining process. For the best possible results, the meat must be entirely submerged in the brining solution for the entire process time.

In order to accomplish the maintaining of the full submergence of the meat during the entire brining process, the present invention includes a series of paired inwardly formed tabs located at diametrically opposite points along the circumference of the container or vessel and at identical distances measured from either the bottom or the open top of the container. Inserted into the container or vessel and positioned below one of the sets of paired tabs is a locking plate that is purposed to retain the desired foodstuff below a predetermined level in the container so that the entire foodstuff for brining is fully submerged within the brining solution. The plate is manually placed in the desired position by inserting it vertically downward within the vessel with each of its cooperating paired cutouts passing beyond any number of the series of paired tabs until the desired height is reached. Upon reaching the desired height above the bottom of the container, with the foodstuff below the locking plate, the plate is rotated to engage the paired tabs retaining the plate between the tab sets immediately above and below the desired height position of the locking plate. By positioning the locking plate in the manner described, the foodstuff, i.e., certain meat types, is maintained in position between the bottom of the vessel and the locking plate in order that the meat is entirely submerged in the brining solution for the entire process time.

The brining solution may be premixed in the container or vessel, or added following the placement of the meat therein and the locking plate put into position. The brining solution should reach at least a depth in the container that reaches to the locking plate, if not a depth that covers the plate. The brining apparatus with the foodstuff and the brining solution are then continuously chilled for the prescribed time period for best infusion of the brining solution into the foodstuff. Following the end of the brining process the foodstuff is removed from the brining apparatus and cooked in the desired method. The infused brining solution tends to enhance the flavor and texture of the foodstuff so as to be more moist and flavorful after cooking.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is an exploded view of the food brining container of the present invention.

FIG. 2 is a cross-sectional view of the food brining container of the present invention.

FIG. 3 is a top view of the food brining container of the present invention with the lid removed showing the intermediate locking plate positioned within the container.

FIG. 4 is a top view of the food brining container of the present invention with the lid removed showing a first alternative structure of the intermediate locking plate positioned within the container.

FIG. 5 is a top view of the food brining container of the present invention with the lid removed showing a second alternative structure of the intermediate locking plate positioned within the container.

FIG. 6 is a cross-sectional view of the food brining container of the present invention showing a third alternative structure for maintaining the foodstuff submerged within the brining solution in the container.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

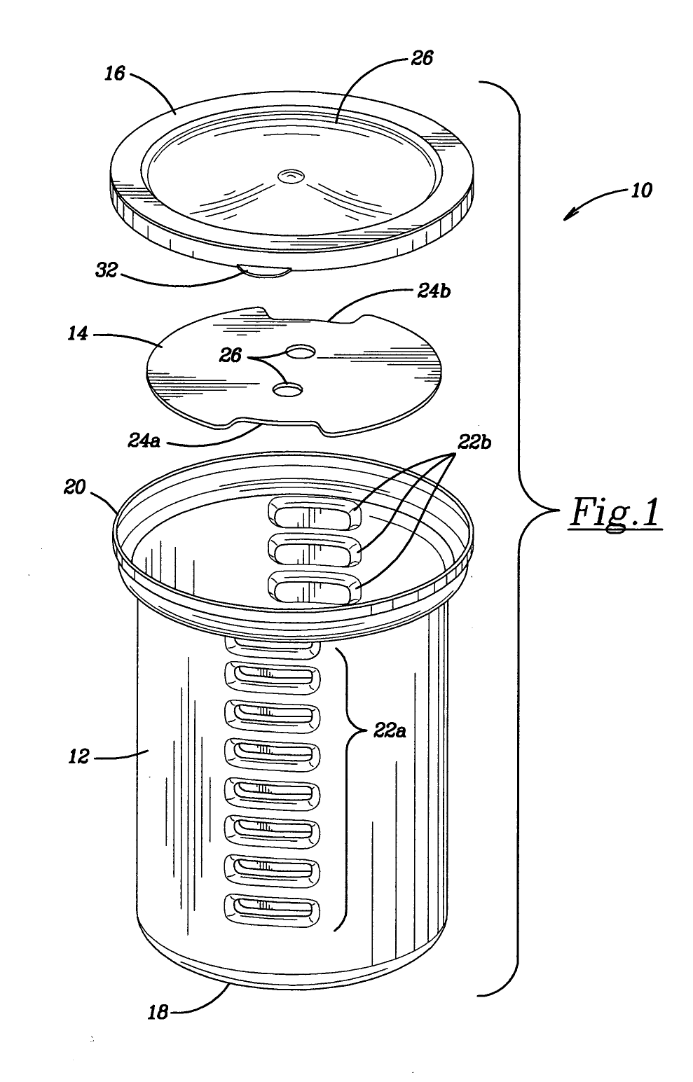

Referring now to the drawings in detail, where like numerals refer to like parts or elements, there is shown in FIG. 1 the brining apparatus 10 of the present invention. The brining apparatus 10 includes a container or vessel 12, a locking plate 14, and a cap or lid 16.

The vessel 12 is shaped substantially as a cylinder having a reinforced bottom 18 and a slightly expanded rim 20 over which the cap 16 snap fits for providing a tight closure to the brining apparatus 10.

Positioned at various vertical distances above the bottom 18 of the vessel 12 are a series of inwardly extending paired tabs 22a, 22b situate along the circumference of the wall of the vessel 12 at points diametrically opposite one another. Each of the tabs 22a, 22b extends inward into the space that forms the cylindrical portion of the vessel 12 and are arrayed to provide a locking position for the plate 14 such that the plate 14 is substantially in parallel relationship to the bottom 18.

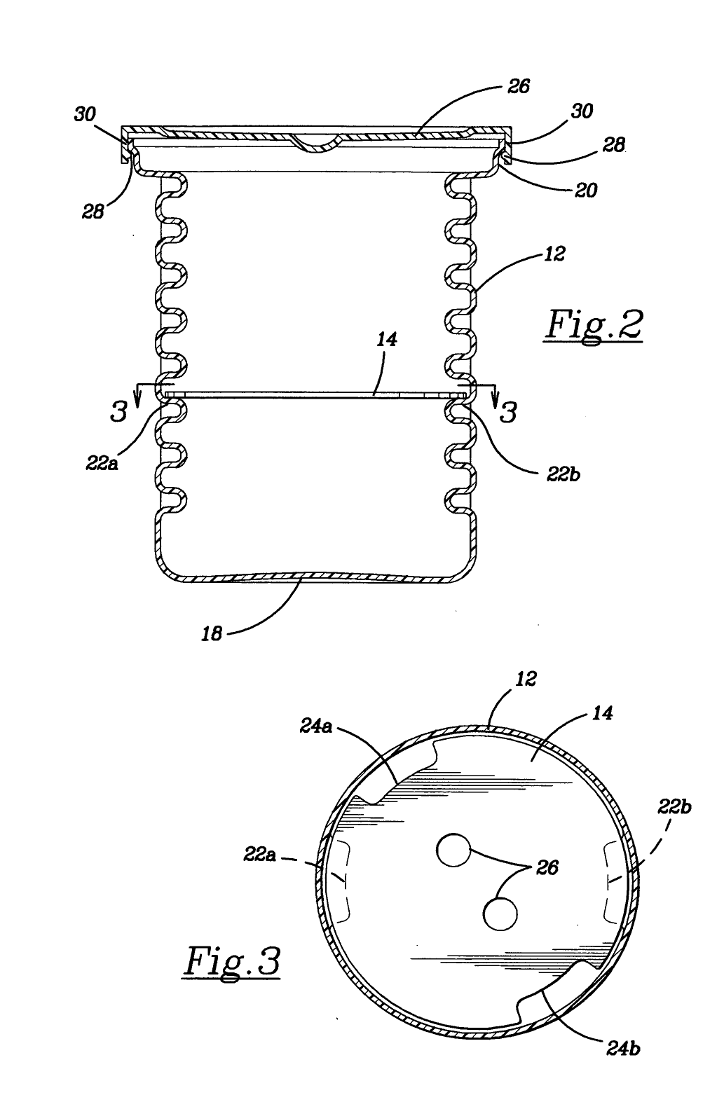

As shown in FIG. 2, each of the tabs 22a, 22b are situate diametrically opposite one another at a series of different distances above the bottom 18 of the vessel 12 and extending upwards to the rim 20. Each of the tabs 22a, 22b are configured identically to the others having an approximate horizontal dimension of 2 inches, a vertical dimension of approximately ½ inch, and an inward extension of approximately ¾ inches. The tabs 22a, 22b are vertically spaced apart any of a number of predetermined distances depending upon the overall height of the vessel 12 and the preselected number of tabs to be utilized for the vessel height. In the embodiment present in FIGS. 1 and 2, there are eight tabs 22 that extend from just above the bottom 18 to the rim 20. In this configuration, the distance between the tabs is approximately ½ inch providing for an overall height of the vessel 12 of approximately 14 inches. The number of tabs 22a, 22b shown is merely one example of the arrangement of tabs that could be utilized to achieve the same result.

Referring to FIG. 3, the locking plate 14 has diametrically opposite cutouts 24a, 24b that are dimensioned to cooperate with the paired tabs 22a, 22b by being able to pass over the paired tabs 22a, 22b by manually moving the plate 14 in the vertical direction by using the two finger holds 26. The plate 14 is moved downward into the vessel 12, over any number of paired tabs 22a, 22b, until the desired height is attained to retain the foodstuff totally within the brining solution contained within the vessel 12. Once the desired height is reached, the locking plate 14 is rotated so that the cutouts 24a, 24b are rotated away from the paired tab 22a, 22b channel such that the outer portions along the circumference of the plate 14 engage against the selected paired tabs 22a, 22b retaining the plate 14 in the desired vertical position above the bottom 18 of the vessel 12.

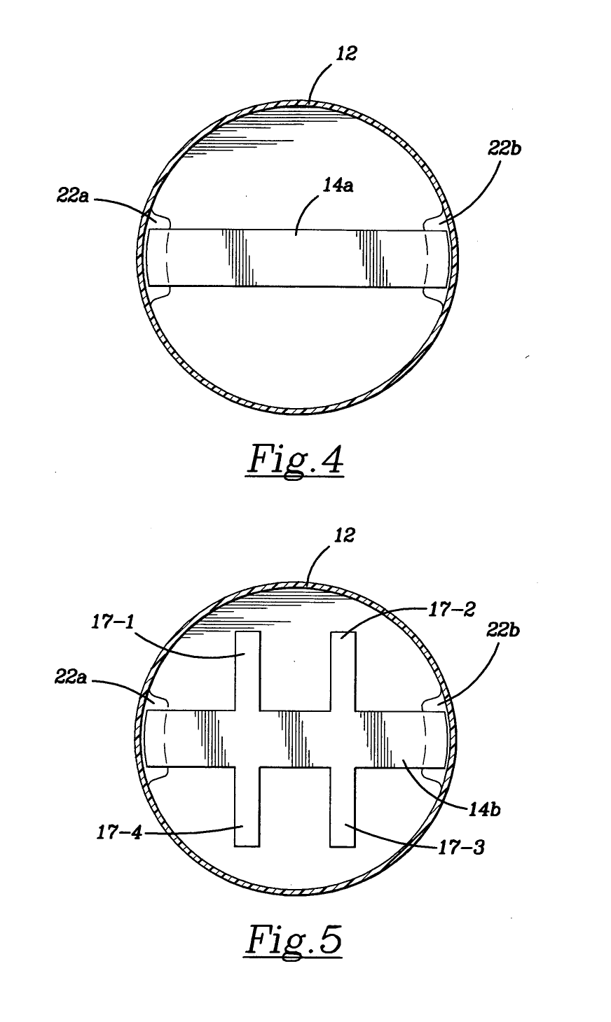

Referring to FIG. 4, there is shown an alternative locking plate or bar 14a that is dimensioned to extend between the selected paired tabs 22a, 22b across the container 12. The bar is manually moved downward into the container 12, bypassing any number of paired tabs 22a, 22b, until the desired height is attained to retain the foodstuff totally submerged in the brining solution. When the desired height is reached, the locking bar 14a is rotated into alignment with the selected paired tabs 22a, 22b such that its respective ends engage each of the paired tabs 22a, 22b retaining the locking bar or plate 14a in the desired vertical position above the bottom 18 of the vessel 12. The locking plate 14a provides a view of the foodstuffs submerged in the brining solution without the need to remove the locking plate 14 in order to check on the foodstuffs during the brining process.

Another alternative locking plate or bar 14b is shown in FIG. 5. In this alternative structure, the bar 14b not only extends between the paired tabs 22a, 22b, but also extends laterally outward from the sides of the locking bar 14b with a plurality of arms 17-1 through 17-4 to retain the foodstuff below the level of the locking bar or plate 14b. The second alternative locking plate or bar 14b is dimensioned to extend between the selected paired tabs 22a, 22b across the container 12. The bar is manually moved downward into the container 12, bypassing any number of paired tabs 22a, 22b, until the desired height is attained to retain the foodstuff totally submerged in the brining solution. When the desired height is reached, the locking bar 14b is rotated into alignment with the selected paired tabs 22a, 22b such that its respective ends engage each of the paired tabs 22a, 22b retaining the locking bar or plate 14a in the desired vertical position above the bottom 18 of the vessel 12. In addition, with locking bar 14b, the arms extend outward from the sides of the locking bar 14b such that the arms 17-1 through 17-4 extend toward the inner wall of the vessel 12 to extend the reach of the locking bar 14b to retain smaller foodstuffs below the bar and submerged in the brining solution, but without the need for the locking plate 14 as described above. The locking plate 14b also provides a view of the foodstuffs submerged in the brining solution without the need to remove the locking plate 14 in order to do so.

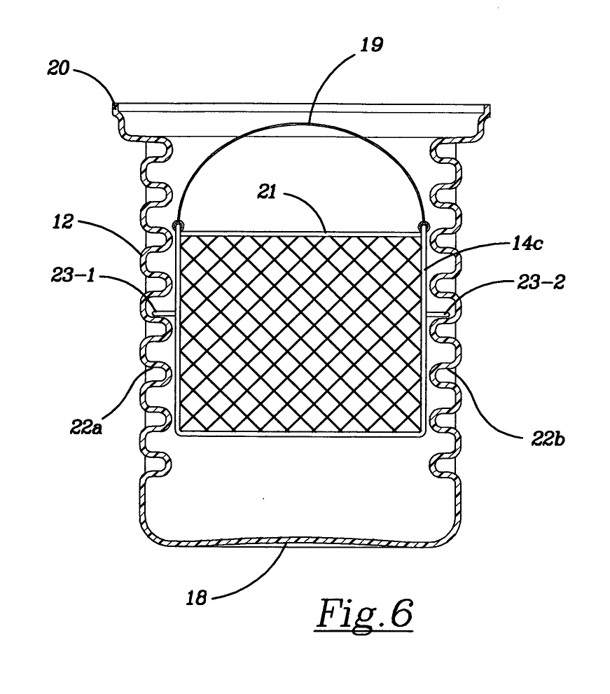

A third alternative structure is shown in FIG. 6 which may be described as a basket 14c. The basket 14c serves a dual purpose as both a collector of very small foodstuffs for lowering into the brining solution while retaining the small foodstuffs together in a flow through containment arrangement and as a flow through submergence retention device for exercising downward force upon a foodstuff that is positioned below it in the container 12. In the second mode of use, the basket 14c is utilized as a retainer for keeping the foodstuff situated below it toward the bottom 18 of the container 12, not allowing the foodstuff to float upward by self-buoyancy and partially emerge from the brining solution. This is accomplished by placing the foodstuff in the container 12 and positioning the basket 14c above the foodstuff such that the basket 14c, by use of diametrically opposite tab engaging arms 23-1, 23-2, engages any of the paired sets of tabs 22a, 22b of the vessel 12 and is retained in position by rotating the basket to engage the engaging arms 23-1, 23-2 with the corresponding paired tabs 22a, 22b. The basket 14c is manually maneuvered by use of a handle 19 attached at opposite points along its upper rim 21.

Alternatively, the basket 14c is utilized as a flow through containment device for retaining small foodstuffs in close proximity to each other for lowering into the vessel 12 and the brining solution. The basket is retained in the brining solution, as described above, by engaging any of the paired sets of tabs 22a, 22b with the tab engaging arms 23-1, 23-2, and retained in that position by rotationally engaging the tabs. Moreover, the basket 14c is unique in that it can serve the dual role of both retaining a submerged foodstuff at or near the bottom 18 of the vessel 12 while simultaneously holding a number of smaller foodstuffs within its flow through basket such that two foodstuffs can be brined simultaneously.

Looking again at FIGS. 1 and 2, the cap or cover 16 has an inner area 26 that can flex as the cap 16 is snapped in place or removed. Along the periphery of the cap 16 is a rounded ridge 28 that fits over a slightly outward extension 30 of rim 20 to create a snap fit of the cap 16 against the rim 20. The ridge 28 and cooperating extension 30 retain the cap 16 in position until manually removed. Additionally, there is a lifting tab 32 along the periphery of the cap 16 to assist in lifting off and disengaging the cap 16 from the rim 20 of the vessel 12.

The brining apparatus 10 may be manufactured of a non-reactive metal to the salt brine, or from a food grade polymer, having the appropriate wall thickness to withstand the outward pressure of the brining solution and foodstuff weight to resist distortion, cracking, or other distension accompanying continued use. The materials must be able to resist the corrosive effects of the brining solution and the reduced temperature for the brining process without degrading. In use, the brining apparatus 10 is to remain sealed off from the external environment until the cap or cover 16 is removed and the foodstuff removed for cooking.

Use of the brining apparatus 10 of the present invention consists of three steps. First, the brining solution is prepared according to the individual tastes of the person cooking the foodstuff with a view towards the quantity of the foodstuff to be infused with the brining solution. The brining solution may be mixed in, or mixed elsewhere and subsequently placed in the vessel 12 and then chilled to create the appropriate temperature environment for the foodstuff. Second, the selected uncooked foodstuff, i.e., meat, poultry or fish, is placed into the vessel 12 making sure that the foodstuff is entirely submerged in the brining solution. Third, to make certain that the buoyancy of the foodstuff does not lift the foodstuff partially out of the brining solution during the brining period; the locking plate 14 (or any of the alternative structures described above, i.e., the cross-vessel bar 14a, the cross-vessel bar with arms 14b or the basket 14c) is appropriately positioned under the selected paired tabs 22a, 22b so as to retain the foodstuff entirely submerged in the brining solution for the time period of the brining process.

The time period for the brining process will vary and is dependent upon the size (weight) or quantity of the foodstuff being infused with the brining solution, as well as the type of foodstuff, meat, poultry or fish that is being infused with the brining solution. The last step is to snap the cap 16 in place atop the vessel 12 and the brining apparatus 10 is placed into a refrigeration unit for chilling the brining solution and foodstuff to a consistent temperature in the range of 32° F. to 40° F. The brining apparatus 10 remains at the desired temperature for the length of time calculated for the brining solution to be maximally infused into the foodstuff. Some of the brining infusion times can be listed as follows:

| | | |
|---|---|---|
| Whole chicken | 3-8 | hours |
| Chicken pieces | 1-2 | hours |
| Whole turkey | 12-48 | hours |
| Turkey breast | 4-8 | hours |
| Cornish game hen | 1-2 | hours |
| Pork chops | 2-6 | hours |
| Pork tenderloin | 2-8 | hours |
| Whole pork loin | 24-72 | hours |
| Salmon | 24-48 | hours |

The thickness of the foodstuff, as well as its weight, is determinative of the time necessary to properly infuse the brining solution into the foodstuff. The chart above is only advisory as to the length of time necessary for a complete brining process.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A foodstuff brining means comprising a substantially cylindrical container sized to retain both a brining solution and any number of foodstuffs to which the brining solution is to be infused, a series of sets of paired inwardly extending tabs positioned at locations diametrically opposite to each other along the outer wall of the container, a foodstuff submergence retention means dimensioned to fit within the container having the capacity to be moved vertically within the container and to rotationally engage a selected set of paired tabs to retain the foodstuff submergence retention means at the height within the container of the selected set of paired tabs, and a snap-lock cap for retaining the space within the container separate from the outside environment during the brining process.

2. The brining means of claim 1, wherein the foodstuff submergence retention means comprises a flat plate having diametrically opposite cutouts sized to cooperate with the paired tabs of the container and to rotationally engage the selected set of paired tabs at a height sufficient to maintain the foodstuff entirely submerged within the brining solution for the brining process.

3. The brining means of claim 2, wherein the flat plate also comprises a manual hand-hold for grasping the flat plate for manual level adjustment and rotational movement within the container.

4. The brining means of claim 1, wherein the foodstuff submergence retention means comprises an extended bar dimensioned to engage at its respective ends the selected paired tab set by rotating said extended bar into alignment with said set of paired tabs at a height sufficient to maintain the foodstuff entirely submerged within the brining solution for the brining process.

5. The brining means of claim 4, wherein the extended bar also comprises a plurality of outwardly extending arms located at preselected spaced positions along the longitudinal length of the extended bar for retaining the foodstuffs submerged in the brining solution.

6. The brining means of claim 1, wherein the substantially cylindrical container may consist of metal that is not reactive with the brining solution or a food grade polymer.

7. The brining means of claim 1, wherein the series of sets of paired tabs are arrayed vertically along the outer wall of the cylindrical container at uniform predetermined heights above the bottom of the container.

8. The brining means of claim 1, wherein the foodstuff submergence retention means comprises a flow-through basket dimensioned to extend across the container and a predetermined distance downward into the container having diametrically opposite cutouts sized to cooperate with the paired tabs of the container and to rotationally engage the selected set of paired tabs at a height sufficient to maintain the foodstuff entirely submerged within the brining solution for the brining process, said basket capable of retaining foodstuffs within the basket, below the basket, or both at a height sufficient to maintain the foodstuffs entirely submerged within the brining solution for the brining process.

9. The brining means of claim 8, wherein the flow-through basket also comprises a manual hand-hold for grasping the basket for manual level adjustment and rotational movement within the container.

10. The brining means of claim 1, wherein the cap has an inwardly extending ridge along the inner periphery of the cap that mates with and extends over the rim of the container to create a snap fit between the cap and the container.

11. The brining means of claim 1, wherein the cap has a lifting tab along the outer periphery of the cap to assist in lifting off and disengaging the cap from the rim the container.
